(19) United States
(12) Patent Application Publication
(10) Pub. No.: US 2025/0265903 A1
(43) Pub. Date: Aug. 21, 2025

(54) PULLTAB GAMING

(71) Applicant: USA Pulltabs LLC, River Falls, WI (US)

(72) Inventors: Anna Schmitz, Vadnais Heights, MN (US); Andrew Schmitz, Vadnais Heights, MN (US)

(73) Assignee: USA Pulltabs LLC, River Falls, WI (US)

(21) Appl. No.: 18/774,631

(22) Filed: Jul. 16, 2024

Related U.S. Application Data
(63) Continuation-in-part of application No. 18/605,766, filed on Mar. 14, 2024.
(60) Provisional application No. 63/554,909, filed on Feb. 16, 2024.

(51) Int. Cl. G07F 17/32; G06K 7/14

(52) U.S. Cl. CPC G07F 17/3246; G06K 7/1413; G06K 7/1417; G07F 17/3223; G07F 17/329

(57) ABSTRACT

A pulltab game includes a set of pulltab cards, wherein each winning card within the set comprises a prize-verification code. In some examples, the prize-verification code is encoded by a scannable code printed underneath one of the perforated tabs of the winning card. A prize-verification device is configured to scan the scannable code to verify a prize-verification code for the winning card. The prize-verification device can include a kiosk machine, a point-of-sale (POS) terminal, and/or a handheld mobile optical scanner.

### PRIORITY CLAIM

This U.S. non-provisional utility patent application claims priority to:
U.S. Provisional Patent Application No. 63/554,909, filed on Feb. 16, 2024, and entitled “PULLTAB GAMING”;
U.S. Non-Provisional patent application Ser. No. 18/605,766, filed on Mar. 14, 2024, and entitled “PULLTAB GAMING”; and
U.S. Design patent application Ser. No. 29/934,702, filed on Mar. 27, 2024, and entitled “PULLTAB CARDS.”

The entire contents of each of these applications are hereby incorporated by reference.

### FIELD OF TECHNOLOGY

The present disclosure generally relates to card-based games and lottery-type games, including collectible trading cards and pulltab games.

### BACKGROUND

“Pulltabs” (or “pull-tabs”) is an incredibly popular lottery-type game played in bars, pubs, breweries, and restaurants throughout the world. Known also by the names “pop-opens,” “break-opens,” and “pickle cards,” pulltabs involves a set of small cardboard cards (or “tickets”) available for purchase by customers of the hosting establishment. Often, a ticket booth staffed by a designated vendor manages sales of the cards, however, bartenders or other employees of the establishment can run the game as well. Typical pulltab cards include two or more cardboard layers coupled together-a bottom layer, featuring one or more randomized gaming entries; and a perforated top layer adhered overtop of the bottom layer to initially conceal the gaming entries. After purchase, the player can rip open a set of perforated strips (or “tabs”) on the top layer of the card in order to reveal the gaming entry concealed underneath. Upon revealing a “winning” gaming entry, the player can return the opened card to the vendor in exchange for a cash prize.

### SUMMARY OF THE INVENTION

Disclosed herein are various example systems, devices, and methods for automating certain aspects of a pulltab game, as well as a set of associated ornamental designs of various components.

In some examples, a pulltab-game system includes: a vending machine configured to retain and dispense a set of pulltab cards of a pulltab game; and a prize-verification device configured to: scan a prize-verification code displayed on a pulltab card from the set of pulltab cards; and identify the pulltab card as a winning card.

In some examples, a prize-verification device of a pulltab-game system includes: means for receiving data comprising a set of game data corresponding to a pulltab game; a digital memory configured to store the set of game data; a scanner configured to scan a scannable code printed under a perforated tab on a winning card of the pulltab game; and processing circuitry configured to: determine a prize-verification code encoded by the scannable code printed on the winning card; identify a winning entry within the set of game data that includes the prize-verification code; determine, from the winning entry, a prize denomination corresponding to the prize-verification code; and output an indication of the prize denomination for display, or cause the prize-verification device to output a cash prize corresponding to the prize denomination.

In some examples, a non-tangible, computer-readable medium encodes program instructions that, when executed by a processor, cause the processor to: determine, based on a scanned code printed on a pulltab card, a prize-verification code encoded by the scanned code; verify, based on the prize-verification code, that the pulltab card is a winning card; determine, based on the prize-verification code, that the winning card has not already been redeemed; and responsive to determining that the winning card has not already been redeemed, output an indication of a cash prize associated with the winning card.

The aspects, features, advantages, benefits, and objects of the invention will become clear to those skilled in the art by reference to the following description, claims and drawings.

### BRIEF DESCRIPTION OF THE DRAWINGS

FIG. 1 is a conceptual diagram of an automated pulltab-game system, in accordance with techniques of this disclosure.

FIG. 2 is a conceptual diagram of a portion of the pulltab-game system of FIG. 1, showing some example components thereof.

FIG. 3 is a perspective view of an example pulltab-card vending machine of the system of FIG. 2.

FIG. 4A is a front view of an example collectible pulltab card from the system of FIGS. 1 and 2.

FIG. 4B is a back view or rear view of the collectible pulltab card of FIG. 4A, having a set of perforated tabs in a “sealed” or “closed” configuration.

FIG. 4C is a back view of the pulltab card of FIGS. 4A and 4B, with its perforated tabs in an “unsealed” or “open” configuration.

FIG. 5A is a front view of a first example prize-verification device for the system of FIG. 2.

FIG. 5B is a perspective view of a second example prize-verification device for the system of FIG. 2.

FIG. 5C is a front view of a third example prize-verification device for the system of FIG. 2.

FIG. 6 is a spreadsheet depicting an example of a set of pulltab-game data for the system of FIG. 2.

FIG. 7 is a conceptual block diagram of an example central computing system of the pulltab-game system of FIG. 2.

FIG. 8A is a screenshot of an example graphical user interface (GUI) of a website run by the central computing system of FIGS. 2 and 7.

FIG. 8B is a screenshot of an example GUI of a customized Customer-Relationship Management (“CRM”) software application run by the central computer of FIGS. 2 and 7.

FIGS. 9A-9L are screenshots of example GUIs of the CRM application of FIG. 8B.

FIG. 10 is a flowchart illustrating a method of running an automatic pulltab game.

### DETAILED DESCRIPTION

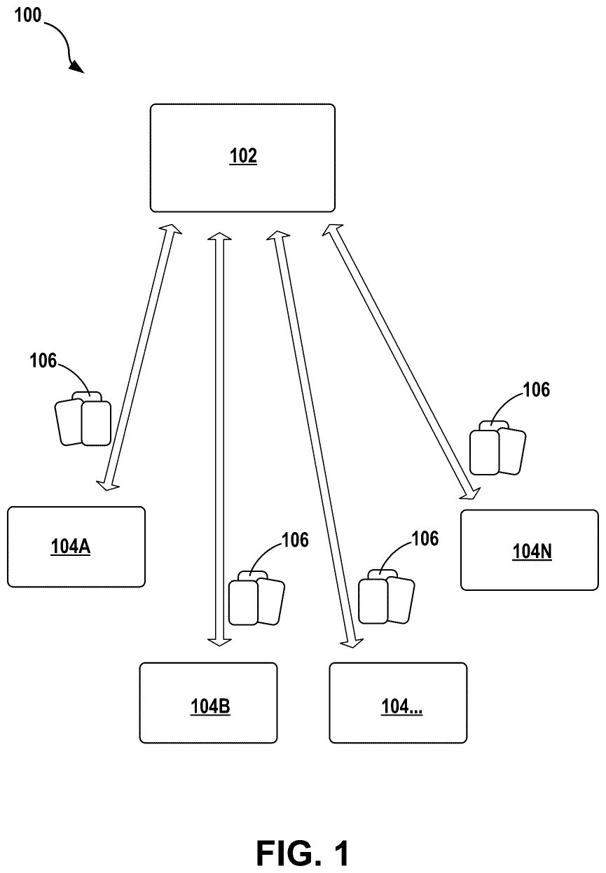

In general, the present disclosure is directed to systems, devices, and techniques for automating one or more aspects of a pulltab game and, by extension, managing an expanded network of pulltab games all running concurrently, thereby enabling the games to be played significantly faster, cheaper, more accurately, more securely, and efficiently scaled to a wider audience. For instance, FIG. 1 is a conceptual diagram of an example automatic pulltab-game system 100, in accordance with the techniques of this disclosure. As illustrated in FIG. 1, system 100 includes a central manager 102 and a plurality of game-hosting establishments 104A . . . 104N, such as bars, pubs, restaurants, etc.

Upon request, central manager 102 provides sets of specialized, collectible pulltab cards 106 such that the respective pulltab games may be hosted within the various contracting establishments 104. As described herein, central manager 102 manages one or more additional aspects of the pulltab games, such that, from the perspective of the hosting establishments 104, the games are at least partially (and in some examples, fully) automated. Of particular note among the numerous advantages of described below is the total elimination of cheating. That is, unlike with all other known pulltab-game systems, a player is entirely prevented from attempting to redeem a winning pulltab card at more than one hosting establishment 106 in order to unfairly collect the same prize multiple times.

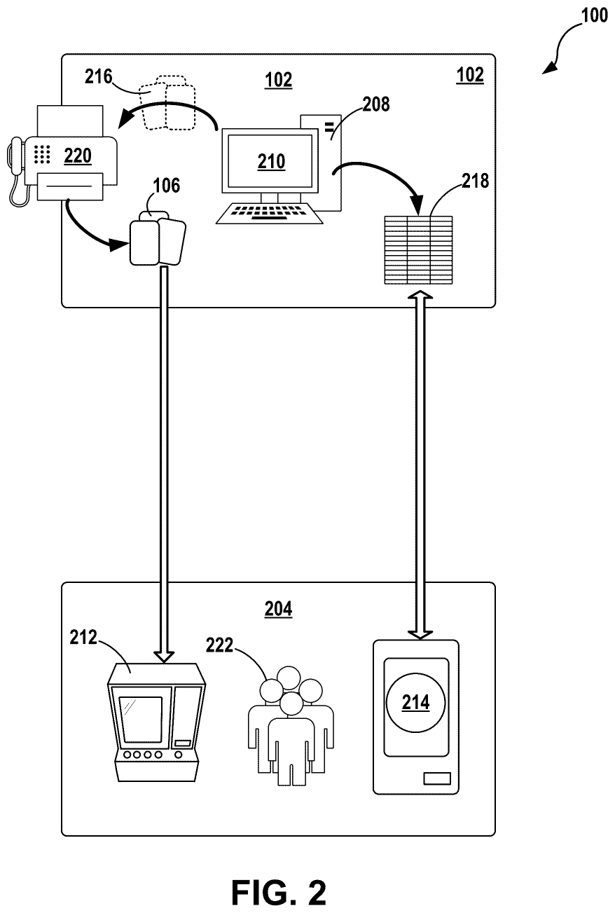

FIG. 2 is a conceptual diagram of a portion of system 100 of FIG. 1, specifically, illustrating an example relationship between central manager 102 and a single hosting establishment 204 (e.g., any one of establishments 104 of FIG. 1). As illustrated in FIG. 2, central manager 102 includes a computer network 208 (or simply, “computer 208”) configured to execute a uniquely tailored Customer-Relationship Management (“CRM”) software application 210. System 100 further includes a card-vending machine 212 and a prize-verification device 214 located within hosting establishment 204 (i.e., within each hosting establishment 104A . . . 104N of FIG. 1).

During operation of system 100, in response to the appropriate user input, central computing device 208 is configured to run CRM 210 in order to generate a new pulltab game, which includes a set of graphical card images 216 and a corresponding set of game data 218. As elaborated further below, graphical card images 216 include a number of unique features corresponding to game data 218 in order to facilitate at-least-partial automation of the pulltab game.

Central computer 208 is configured to transmit the graphical card images 216 to a pulltab-card printer 220 via any suitable data-communication conduit, whether wired (e.g., via a local-area network (LAN)) or wireless (e.g., email transmitted via Wi-Fi). Card printer 220 can range from a suitable single-printer device (e.g., a standard inkjet/toner printer), up to a designated mass-printing facility, capable of generating a complete set of physical pulltab cards 106 based on the graphical card images 216. In accordance with certain aspects of this disclosure, and as detailed further below, pulltab cards 106 may be constructed to provide dual gaming functionality-a front side of each card corresponds to a collectible trading-card game, and a back side of each card corresponds to the pulltab game.

The physical pulltab cards 106 are delivered to the game-hosting establishment 204 and securely deposited within a pulltab-card vending machine 212. Meanwhile, a prize-verification device 214 is situated locally to the vending machine 212, e.g., either at the same hosting establishment 204, or within a substantially short (e.g., “walking”) distance away. Although FIG. 2 depicts vending machine 212 and prize-verification device 214 as two physically distinct components, in other examples of system 100, vending machine 212 and prize-verification device 214 are integrated within a common housing to form a single device, or equivalently, a single device is configured with the functionality ascribed to both vending machine 212 and prize-verification device 214.

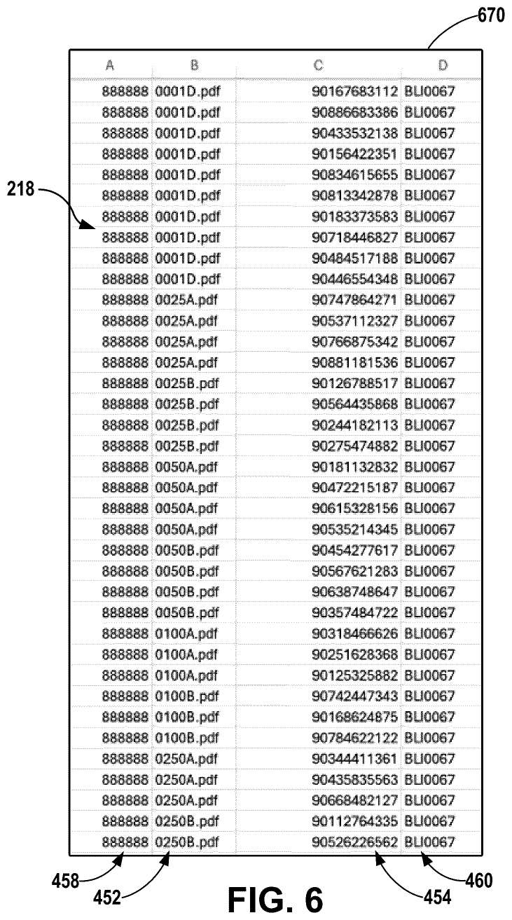

Prize-verification device 214 is configured to receive the set of game data 218 associated with the pulltab cards 106 of a particular game. As detailed further below with respect to FIG. 6, game data 218 can include, for example: a first unique identifier (e.g., a serial number) associated with a particular pulltab game to which all of pulltab cards 106 belong; a second unique identifier for each winning pulltab card from a particular game; and a prize indicator for each winning card. In some cases, game data 218 can be manually uploaded to prize-verification device 214, such as by inserting a USB flash drive, SD card, or other suitable removable digital storage volume, into the device 214, and copying the contents into a local memory of the device 214. Additionally or alternatively, game data 218 can be remotely transmitted to prize-verification device 214 from central computer network 208, such as via a wired and/or wireless network connection. In other examples, game data 218 is not directly transmitted to a local memory within prize-verification device 214, but rather, prize-verification device 214 includes Internet-access capabilities, and is configured to interface with CRM software application 210 via the Internet.

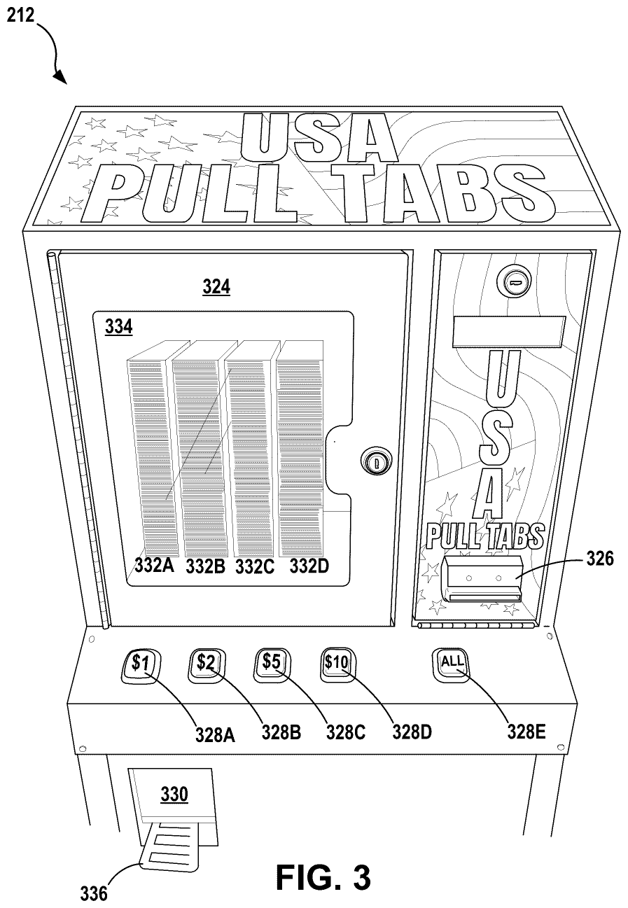

With the physical cards 106 secured within card-vending machine 212, and with game data 218 uploaded locally to prize-verification device 214 (where applicable), the pulltab game can begin. Players 222, such as customers or patrons of the hosting establishment 204, can take turns engaging with card-vending machine 212, a detailed example of which is shown in FIG. 3.

FIG. 3 is a front-perspective view of an example implementation of the pulltab-card vending machine 212 of FIG. 2. As shown in FIG. 3, vending machine 212 includes: a lockable card safe 324, a cash-deposit slot 326, a plurality of selectable buttons 328A-328E, and a pulltab-card-output slot 330.

In the illustrative, non-limiting example depicted in FIG. 3, lockable card safe 324 contains four columns or stacks 332A-332D of pulltab cards, as viewed through transparent window 334. Each column or stack 332 corresponds to one of four different pulltab games running simultaneously. For instance, stack 332A includes pulltab cards available for $1 each, as indicated by button 328A. Stack 332B includes pulltab cards available for $2 each, as indicated by button 328B. Stack 332C includes pulltab cards available for $5 each, as indicated by button 328C. And stack 332D includes pulltab cards available for $10 each, as indicated by button 328D. In other examples, lockable card safe 324 can retain pulltab cards from more, fewer, or different games. For instance, in a different example, columns 332A and 332B could include pulltab cards from the same game, in which case buttons 328A and 328B would display the same dollar amount for purchase.

During use, a player 222 (FIG. 2) initiates a transaction by depositing cash into the cash-deposit slot 326. Upon receiving cash through cash-deposit slot 326, one or more of buttons 328A-328D may be configured to illuminate, indicating which stacks 332 of pulltab cards the player 222 can select from. For instance, if the player 222 deposited $5, then buttons 328A, 328B, and 328C would illuminate, but not button 328D, as the player 222 did not deposit enough cash to purchase a $10 pulltab card from stack 332D. In that case, the player 222 can select from any combination of buttons 328A-328C to purchase a number of pulltab cards collectively adding up to $5. As a few examples, the player 222 could select button 328A five times; or the player could select button 328A three times and button 328B one time; or the player 222 could select button 328C one time.

Vending machine 212 also includes an “ALL” button 328E. By selecting this button, the player 222 indicates to vending machine 212 that they would like to select “all” of their cards from a common stack 332. For instance, rather than pressing button 328A five times in a row, the player 222 could press the “ALL” button 328E, and then press button 328A, and vending machine 212 will automatically begin grabbing pulltab cards drawn from stack 332A, and dispensing each pulltab card 336 outward through card-output slot 330, until either (1) the player's cash deposit is spent, or (2) the player 222 aborts the dispensing by pressing a different button 328. Other examples of vending machine 212 can include additional and/or different types of user-input devices other than pressable buttons 328, such as a digital touchscreen, a joystick, a scroll wheel, or any other suitable mechanism for indicating the player's card-stack selection to vending machine 212.

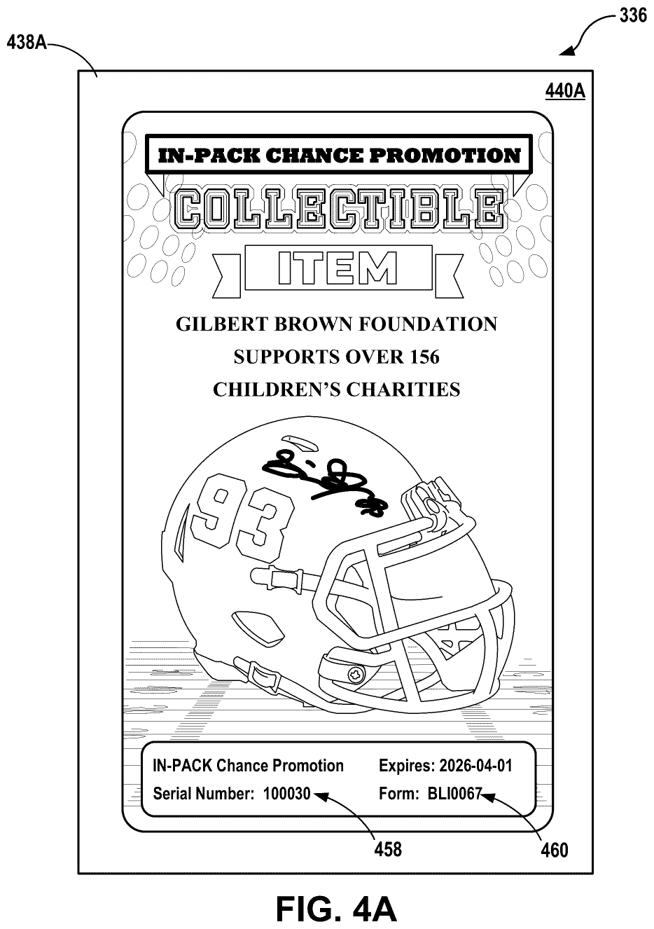

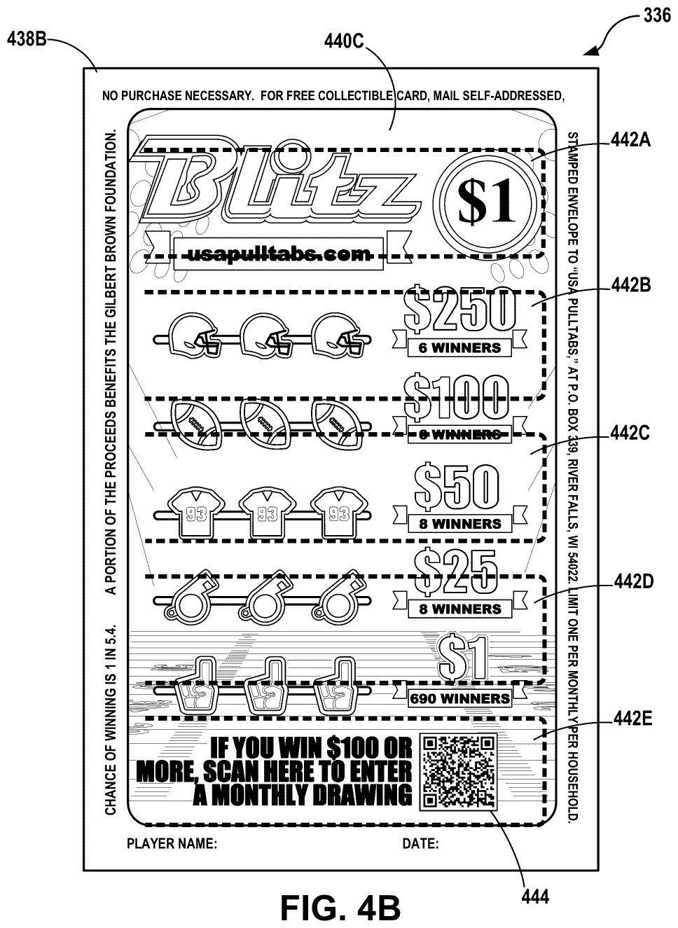

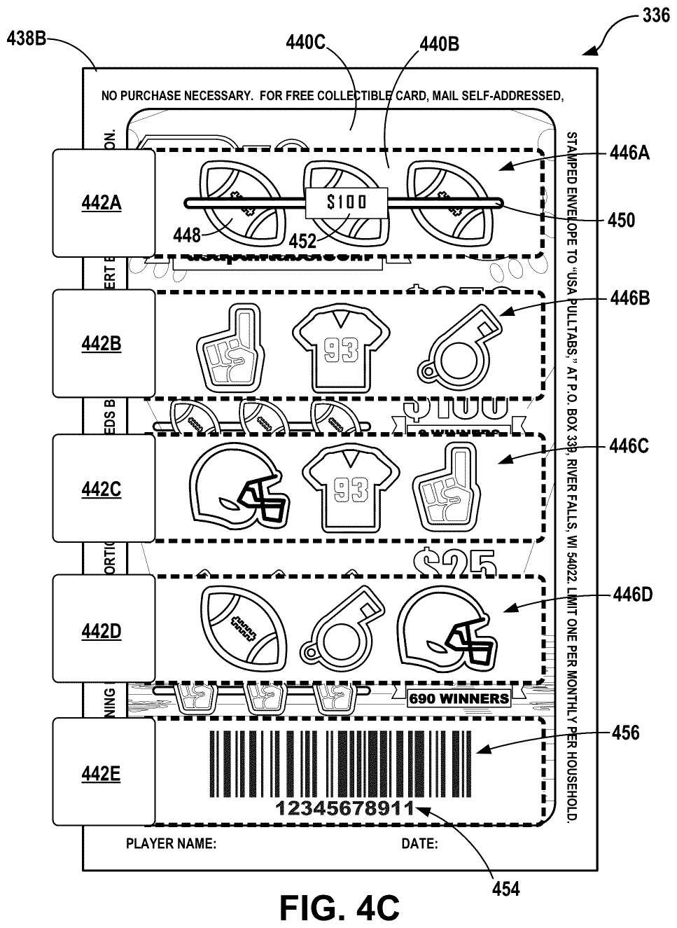

FIGS. 4A-4C depict an illustrative, non-limiting example of a pulltab card 336 (FIG. 3) that may be dispensed from vending machine 212. Pulltab card 336 of FIGS. 4A-4C is one example of such a card belonging to a larger set of pulltab cards 106 (FIG. 1) associated with a common pulltab game.

As referenced above, pulltab cards of the present disclosure can provide dual gaming functionality. For instance, as shown in FIG. 4A, a front side (or “first” side) 438A of pulltab card 336 corresponds to a collectible trading-card game, e.g., featuring graphical imagery associated with an athlete, an anime character, or any other suitable object that belongs to a larger collection of similar (but non-identical) objects.

Concurrently, as shown in FIGS. 4B and 4C, a back side (or “second” side) 438B of pulltab card 336 corresponds to a pulltab game, in accordance with system 100 described throughout this disclosure. Accordingly, in some examples of the present disclosure, each pulltab card 336 is formed from two layers of material (e.g., cardboard, or the functional equivalent). During manufacture of each card 336, printer 220 (FIG. 2) prints graphical imagery onto both surfaces 440A, 440B of a first cardboard layer, and onto just one surface 440C of the second cardboard layer, and then the two cardboard layers are adhesively assembled into the card 336. For instance, as depicted in FIG. 4A, a first printed surface 440A of a first cardboard layer constitutes the “collectible” front side 438A of the assembled pulltab card 336. As depicted in FIGS. 4B and 4C, the second surface 440B of the first cardboard layer, and the first surface 440C of the second cardboard layer, collectively form the “pulltab-game” back side 438B of the assembled card 336.

As shown in FIGS. 4B and 4C, the outer surface 440C of the second cardboard layer of pulltab card 336 defines one or more perforated tabs 442A-442E. In this non-limiting example, back-outer surface 440C defines five vertically aligned perforated tabs 442; other examples of pulltab card 336 can include more than five tabs or fewer than five tabs 442, as desired. As detailed further below, the back-outer surface 440C further includes an outer scannable code 444, such as a quick-response (“QR”) code, a barcode, or the like.

The second cardboard layer is adhered onto the back surface 440B of the first cardboard layer, such that back-inner surface 440B of the first cardboard layer and the back-outer surface 440C of the second cardboard layer face the same direction, i.e., opposite from the direction of the front surface 440A of the first cardboard layer.

In the example shown in FIG. 4C, the player 222 (FIG. 2) has ripped open all five perforated tabs 442A-442E of the second cardboard layer, thereby revealing certain portions of the printed back surface 440B of the first cardboard layer thereunder. Specifically, the printed back surface 440B of the first cardboard layer includes one or more pulltab-game entries 446A-446D, with each game entry 446 strategically positioned underneath a respective perforated tab 442A-442D of the second cardboard layer.

For instance, upon tearing open the first perforated tab 442A, the player 222 discovers that the game entry 446A concealed underneath the tab 442A includes a particular sequence of icons 448 (depicted here as three consecutive football-shaped icons 448), which, under the rules of the corresponding pulltab game, constitutes a winning game entry 446—thus, pulltab card 336 is a winning card.

At the time each pulltab game is originally generated, central computer 208 (FIG. 2) automatically identifies all of the winning game entries for that game, and graphically marks the winning game entries with a horizontal line 450 (which printer 220 prints onto the back surface 440B of the first cardboard layer), in order to simplify and expedite the game for player 222.

Additionally, upon generating a winning game entry 446A, computing device 208 determines a cash prize associated with the winning sequence of icons 448, and generates a numerical cash-prize indication 452 overtop of the winning game entry 446A (or, in other examples, overtop of a different (non-winning) game entry 446B-446D on the same card 336).

Even further, in accordance with the techniques of this disclosure, computing device 208, upon generating a winning game entry 446A, is configured to designate the winning card 336 with a unique identifier, thereby enabling automation of a subsequent portion of the game in which player 222 collects their cash prize. In FIG. 4C, this unique identifier is printed onto the back surface 440B of the first cardboard layer and strategically concealed beneath the fifth perforated tab 442E, and includes both a numeric (or alphanumeric) prize-verification code 454, and an (inner) machine-scannable code 456, such as a barcode, QR code, etc., that digitally encodes the prize-verification code 454.

In the example shown, prize-verification code 454 and scannable code 456 occupy the space on the printed back surface 440B of the first cardboard layer that would otherwise be occupied by a fifth game entry. But since pulltab card 336 is already a winning card, game entries other than the winning game entry 446A are not necessary to be included on the same card.

Prize-verification code 454 is shown in FIG. 4C as an eleven-digit numeric sequence, although other sequences are also contemplated, such as a six-character or seven-character alphanumeric sequence (as just two examples). The prize-verification code 454 is mapped, within game data 218 (FIG. 2), to a unique “game” serial number 458 (FIG. 4A) indicating which pulltab game the card 336 belongs to, when game data 218 is originally generated by central computer 208.

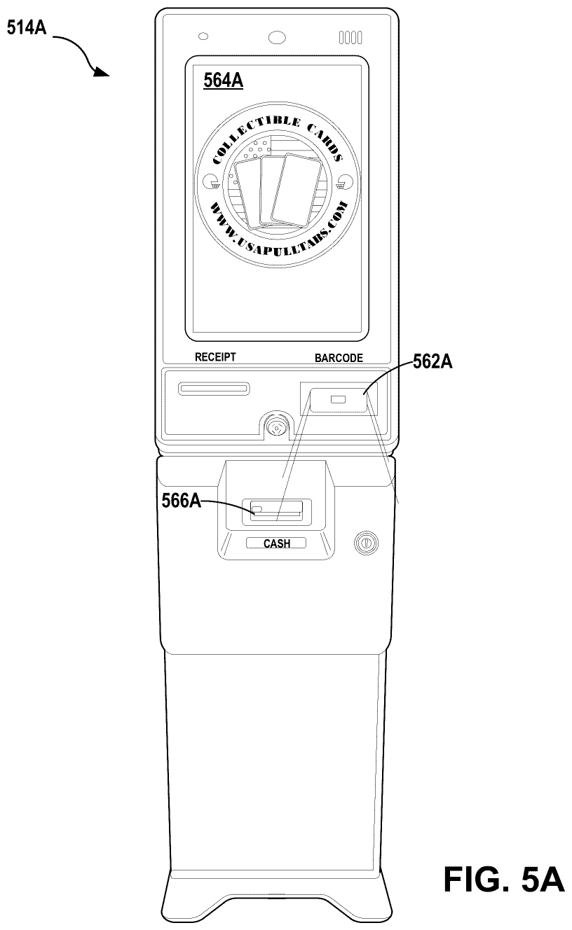

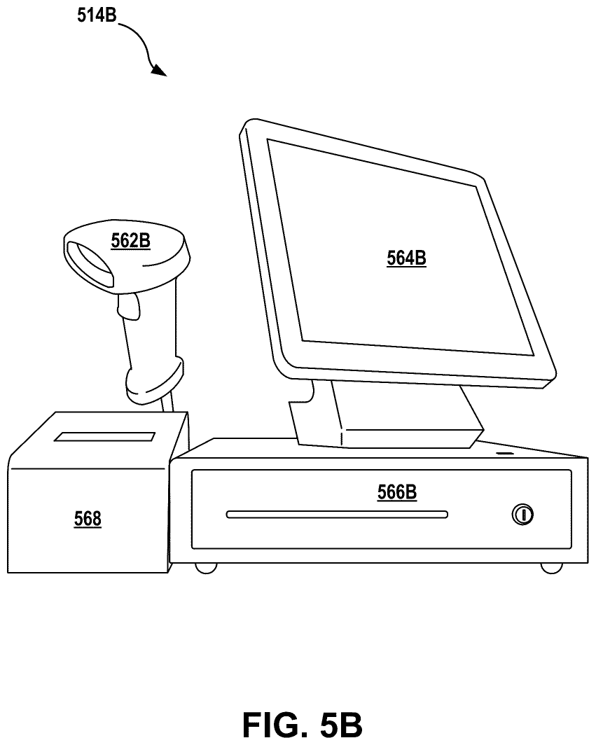

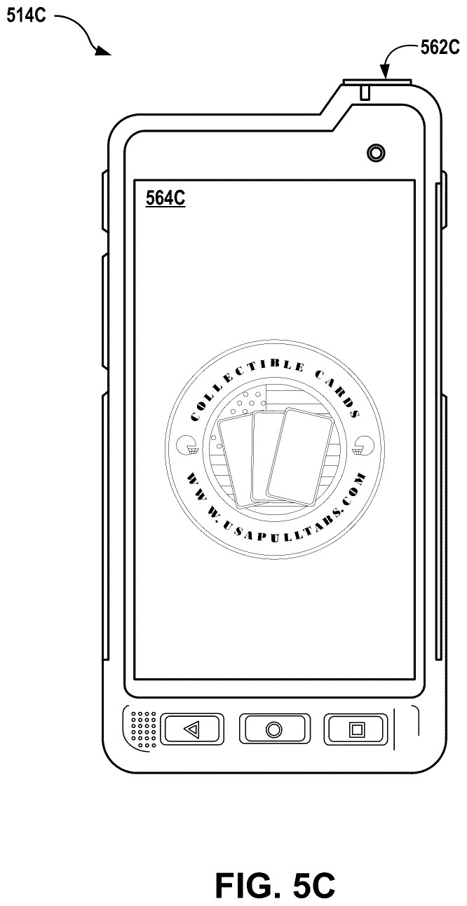

After tearing open the fifth perforated tab 442E to reveal inner scannable code 456, the winning player 222 can then bring the winning card 336 to a local prize-verification device 214 to verify the winning card 336 and claim their prize. FIGS. 5A-5C depict three example implementations 514A-514C, respectively, of prize-verification device 214.

For instance, FIG. 5A is a front view of a first example prize-verification device 514A in the form of a “kiosk” machine. As shown in FIG. 5A, prize-verification kiosk 514A includes an integrated code scanner 562A (i.e., an optical scanner, or the functional equivalent). Upon detecting a valid scannable code 456 (FIG. 4C) placed in front of the scanner 562A, prize-verification kiosk 514A is configured to extract the prize-verification code 454 encoded by the scannable code 456, and either (1) compare the prize-verification code 454 to game data 218 stored in the internal digital memory of prize kiosk 514A, or (2) transmit the prize-verification code 454 via the Internet to central computer network 208 (FIG. 2), whereby central computer network 208 compares the code 454 to game data 218 and replies with a “valid” or “invalid” indication. Additionally or alternatively, prize-verification kiosk 514A can include a user interface 564A, such as a digital touchscreen displaying a graphical user interface (GUI), that enables player 222 to manually enter the prize-verification code 454 from the winning card 336. If prize-verification kiosk 514A identifies a match between the prize-verification code 454 and game data 218, it will automatically dispense a corresponding amount of prize money from cash dispenser 566A. In some examples, prize-verification kiosk 514A can include dual (or even higher-order) functionality. For instance, prize-verification kiosk 514A can be fully functional as an automated teller machine (ATM), and/or a redemption kiosk for other types of games in addition to pulltabs.

FIG. 5B is a front perspective view of a second example prize-verification device 514B in the form of a “point-of-sale” (“POS”) terminal. As shown in FIG. 5B, POS 514B includes an integrated and/or handheld code scanner 562B (i.e., an optical scanner, or the functional equivalent). Upon detecting a valid scannable code 456 (FIG. 4C) placed in front of the scanner 562B, POS 514B is configured to extract the prize-verification code 454 encoded by the scannable code 456, and either (1) compare the prize-verification code 454 to game data 218 stored in the internal digital memory of POS 514B, or (2) transmit the prize-verification code 454 via the Internet to central computer network 208 (FIG. 2), whereby central computer network 208 compares the code 454 to game data 218 and replies with a “valid” or “invalid” indication. Additionally or alternatively, POS 514B can include a user interface 564B, such as a digital touchscreen displaying a graphical user interface (GUI), that enables player 222 to manually enter the prize-verification code 454 from the winning card 336. In some examples, when POS 514B identifies a match between the prize-verification code 454 and game data 218, POS 514B can indicate on display 564B an amount of prize money for an authorized game host to dispense from cash register 566B. In other examples, POS 514B may print, from ticket printer 568, a paper ticket with a scannable code indicating an amount of prize money, in which case the player 222 can then use a separate machine (such as prize-verification kiosk 514A of FIG. 5A) to scan the ticket and automatically dispense the corresponding cash prize.

FIG. 5C is a front perspective view of a third example prize-verification device 514C in the form of a mobile (or “handheld”) scanner device. Two illustrative, non-limiting examples of such a device are the “Sonim Scan XP8” and the “Sonim Scan XP10” manufactured by Sonim Technologies, Inc., of San Diego, California.

As shown in FIG. 5C, mobile scanner 514C includes an integrated code scanner 562C (i.e., an optical scanner, or the functional equivalent). Upon detecting a valid scannable code 456 (FIG. 4C) placed in front of the scanner 562C, mobile scanner 514C is configured to extract the prize-verification code 454 encoded by the scannable code 456, and either (1) compare the prize-verification code 454 to game data 218 stored in the internal digital memory of mobile scanner 514C, or (2) transmit the prize-verification code 454 via the Internet to central computer network 208 (FIG. 2), whereby central computer network 208 compares the code 454 to game data 218 and replies with a “valid” or “invalid” indication. Additionally or alternatively, mobile scanner 514C can include a user interface 564C, such as a digital touchscreen displaying a graphical user interface (GUI), that enables an authorized game host to manually enter the prize-verification code 454 from the winning card 336. In some examples, when mobile scanner 514C identifies a match between the prize-verification code 454 and game data 218, mobile scanner 514C can indicate on display 564C an amount of prize money for the authorized game host to provide to the player 222, such as from cash register 566B of FIG. 5B. In other examples, mobile scanner 514C may print, from an integrated ticket printer (not shown) or from a physically distinct ticket printer 568 (FIG. 5B), a paper ticket with a scannable code indicating an amount of prize money, in which case the player 222 can then use a separate machine (such as prize-verification kiosk 514A of FIG. 5A) to scan the ticket and automatically dispense the corresponding cash prize.

FIG. 6 is a spreadsheet 670 illustrating an example set of game data 218 that might be generated by the appropriate software running on computing device 208 (FIG. 2) and, in some examples (but not all examples) uploaded to local memory of prize-verification device 214. In this example, game data 218 is formatted as a Comma-Separated Values (“.CSV”) file with four data parameters (e.g., columns) for each entry (e.g., row), wherein each entry represents a different winning pulltab card from the same pulltab game. Column A encodes the unique “game” serial number 458 (FIG. 4A) assigned to each pulltab game. Column B encodes a dollar amount 452 (FIG. 4C) of the cash prize for the pulltab card corresponding to that row. For instance, in the value “0001D.pdf,” the number “0001” represents a prize amount of $1, and the letter “D” indicates which game entry 446 (e.g., the fourth game entry 446D concealed underneath the fourth perforated tab 442D) was the winning game entry on the card 336. Column C encodes the prize-verification code 454 for a winning pulltab card 336, which is also encoded by the inner scannable code 456 (FIG. 4C). And Column D encodes an artwork template identifier (ID) 460 (FIG. 4A), which is used by printer 220 (FIG. 2) when printing physical cards 106.

In accordance with techniques of this disclosure, when a winning player 222 collects a cash prize by scanning the inner scannable code 456 on the code scanner 562 of an appropriate prize-verification device 214/514, the prize-verification device 214/514 can be configured to automatically store an indication that the associated prize-verification code 454 has been “claimed,” i.e., such that the same prize cannot be collected multiple times. Equivalently, in example in which the prize-verification device 214/514 interfaces with central computer 208 via the Internet to verify the code 454, central computer 208 can be configured to automatically store an indication that the prize-verification code 454 has been claimed and cannot be subsequently claimed again in the future.

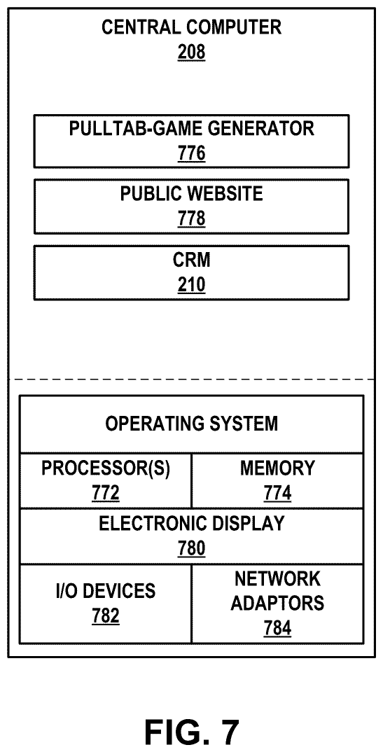

FIG. 7 is a conceptual block diagram of an example implementation of central computer 208 of FIG. 2. Although depicted in FIG. 7 as a single functional unit, in practice, central computer 208 can be or can include one or more communicatively-connected computing devices, e.g., each having a unique processor (or “processing circuitry”) 772 and/or a digital memory 774. For instance, central computer 208 can be or can include a cloud-based server and/or one or more “local” devices. Memory 774 encodes one or more software applications (“apps” or “modules”) for generating and managing pulltab games for a network of customers or clients, such as hosting establishments 104A-104N of FIG. 1.

For instance, as shown in FIG. 7, central computer 208 is configured to run or execute a pulltab-game generator 776. When executed, game generator 776 is configured to automatically generate a new pulltab game that includes a set of game data 218 (e.g. a .csv file), and corresponding digital, graphical pulltab-card images 216 (e.g., a .jpg, .bmp, .webp file etc.), each featuring randomized sets of game entries 446 (FIG. 4C).

Central computer 208 is further configured to host (e.g., store in memory 662) and run (e.g., execute) a public-facing website 778, accessible via the Internet. Players 222 can access website 778 with, for instance, a personal computer, laptop, smartphone, smartwatch, or tablet, in order to learn more information about a pulltab game, or in some cases, to enroll in an additional bonus game.

As one example, a winning player 222 can use their smartphone to scan the outer scannable code 444 (FIG. 4B) on the back side 438B of their winning pulltab card 336. The outer scannable code 444 will direct their smartphone's mobile browser to website 778, where player 222 can enter a “second-chance” drawing to win an additional prize.

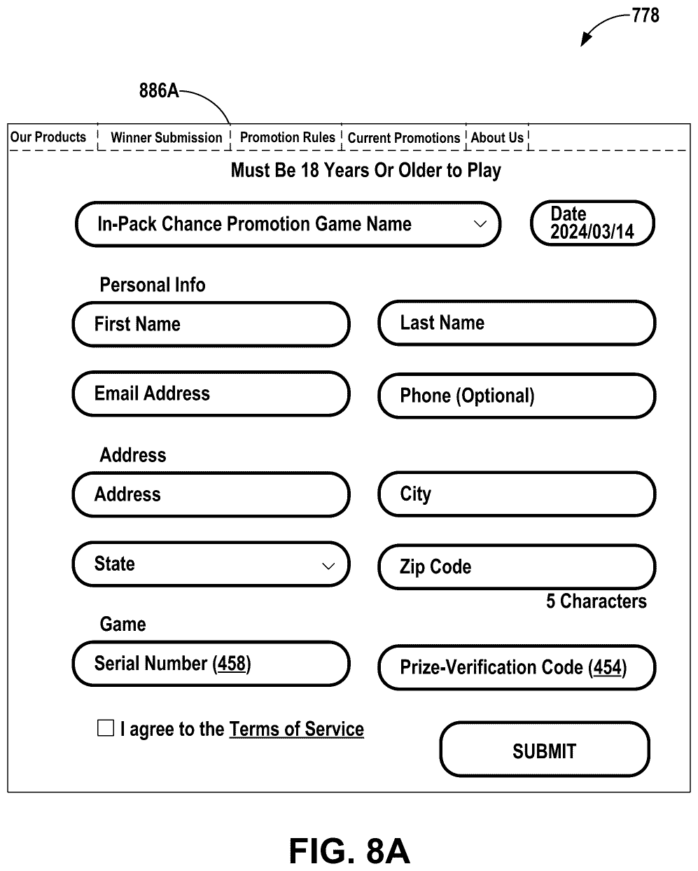

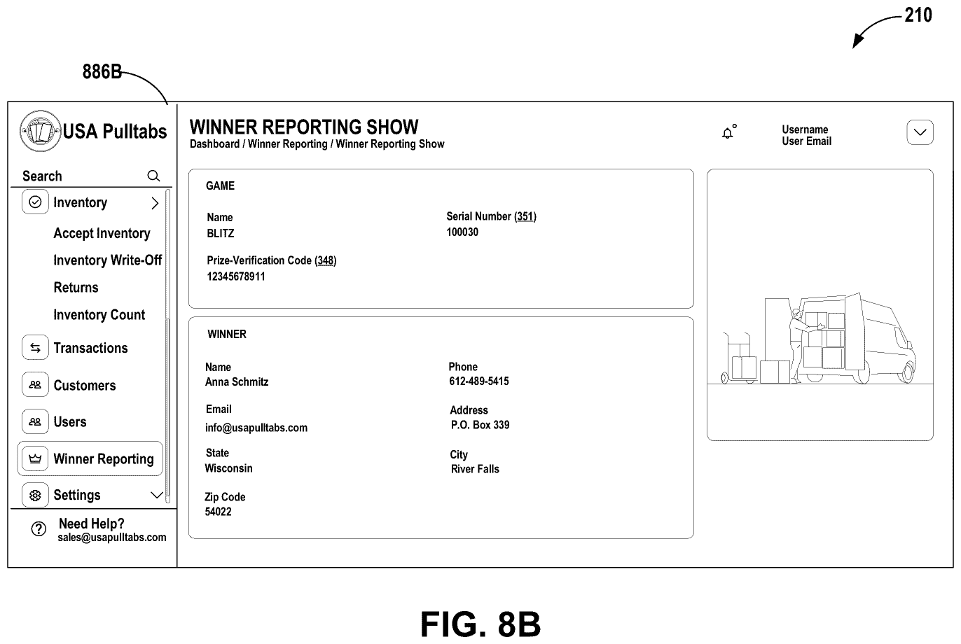

FIG. 8A is a screenshot of an example graphical user interface (GUI) 886A of public-facing website 778 of FIG. 7, and FIG. 8B is a screenshot of an example GUI 886B of a corresponding page of a uniquely tailored Customer-Relationship-Management (CRM) software application 210 run by central computer 208 of FIGS. 2 and 7. As shown in FIG. 8A, GUI 886A enables a winning player 222 to submit their name, contact info, and the prize-verification code 454 from their winning card 336 in order to be entered into a periodic, randomized “second-chance” drawing to win an additional prize. The drawing can occur weekly, monthly, semi-annually, or annually, as a few illustrative examples.

The public-facing website 778 can be configured to interface with CRM 210. For instance, as shown in FIG. 8B, CRM 210 is configured to receive, via website 778, the second-chance drawing entry data from winning player 222. Additionally, CRM 210 can retrieve and consult game data 218 in order to verify the winning player's prize-verification code 454 and confirm their entry into the next drawing. Equivalently, game generator 776 can automatically transmit game data 218 to CRM 210 every time it generates a new pulltab game. In some examples, CRM 210 is configured to run all drawing entries through a validation process by matching each player's entry (e.g., game serial number 458, name of pulltab game, and prize-verification code 454) with game data 218 stored in memory 774. If CRM 210 validates a player's entry, the player's entry receives an positive-validation indicator within GUI 988A, such as by displaying that player's entry in green.

In one non-limiting, illustrative example, CRM 210 can be configured to help run the drawing annually by randomly selecting among all the player entries submitted during the previous calendar year (i.e., January 1 through December 31). The winner of the drawing can be contacted directly using the player's entry data, and announced publicly on website 778. Through CRM 210, every drawing entry is assigned a drawing date to help differentiate between different promotions (e.g., subsequent years' drawings).

In some examples, CRM 210 can also use the player's drawing-entry data to keep track of the number of redeemed winning pulltab cards for each game, as they are purchased and opened over time. Such data can help inform pulltab-game inventory management, another function performed by CRM 210. For instance, central game manager(s) 102 (FIG. 1) can use CRM 210 to help decide whether to either increase or decrease the rate at which new pulltab games are generated, based on the rate at which winning cards 336 are purchased and redeemed.

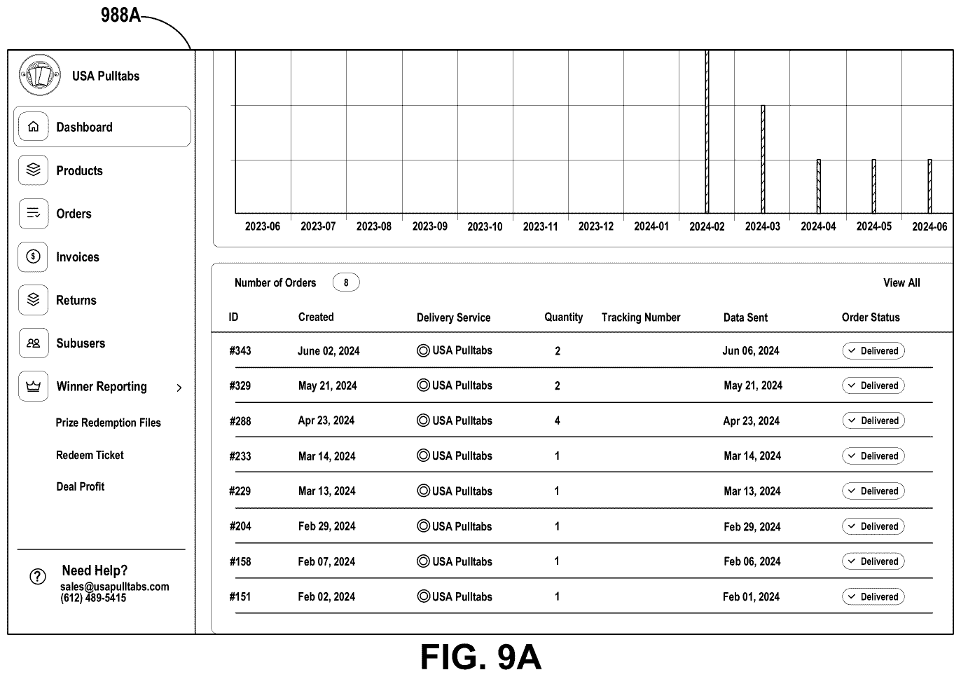

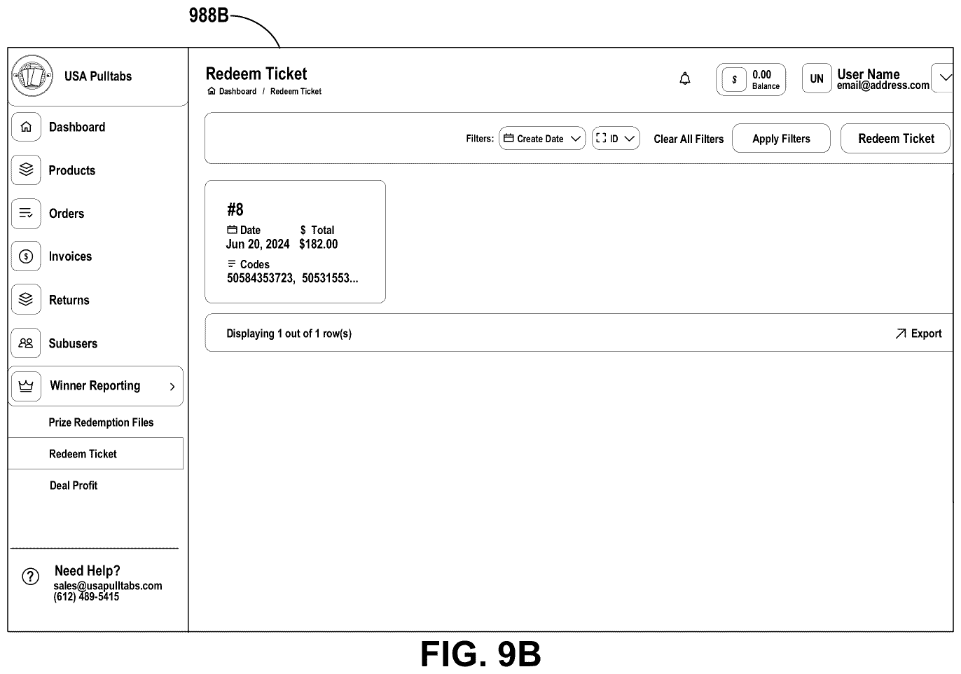

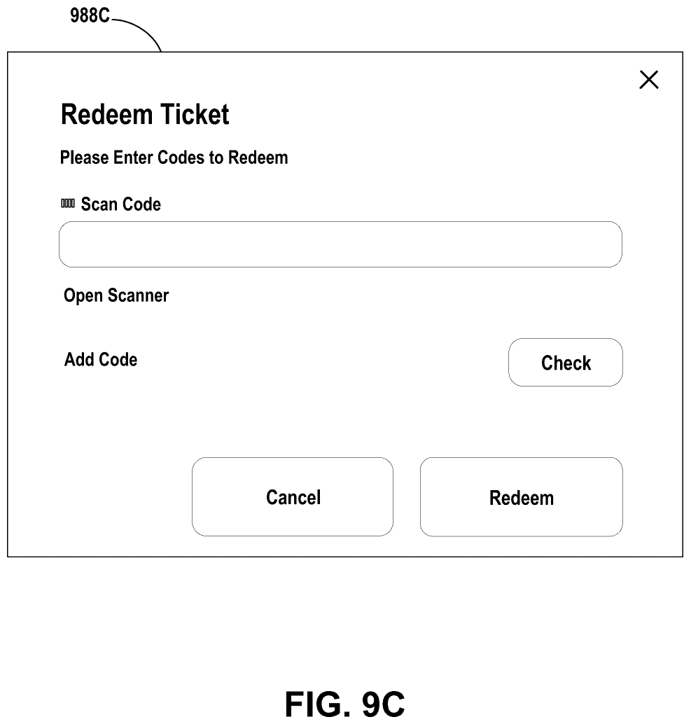

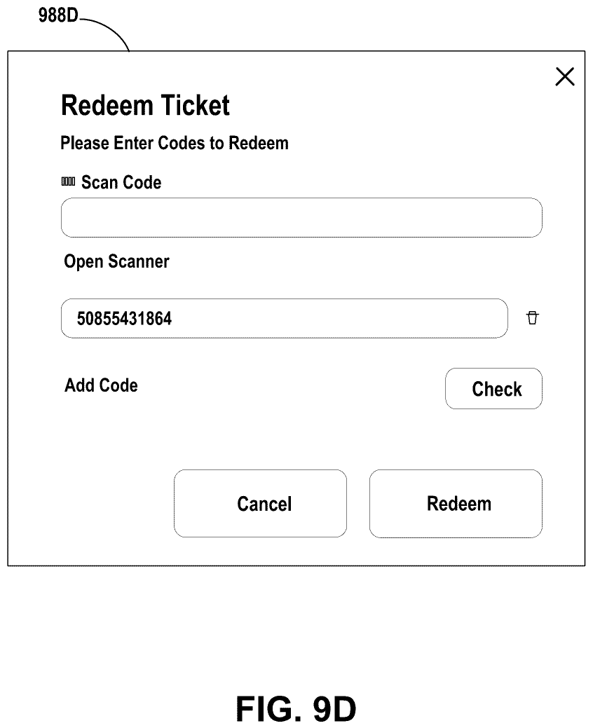

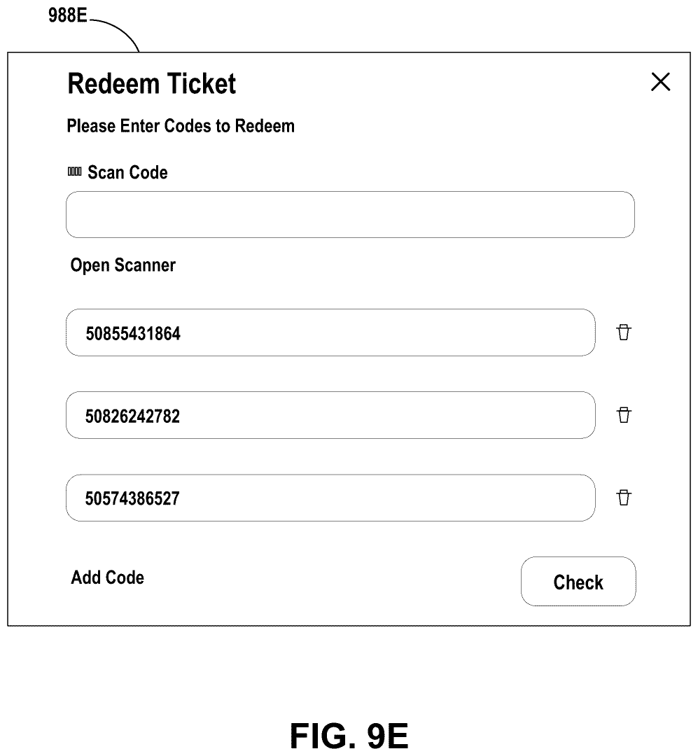

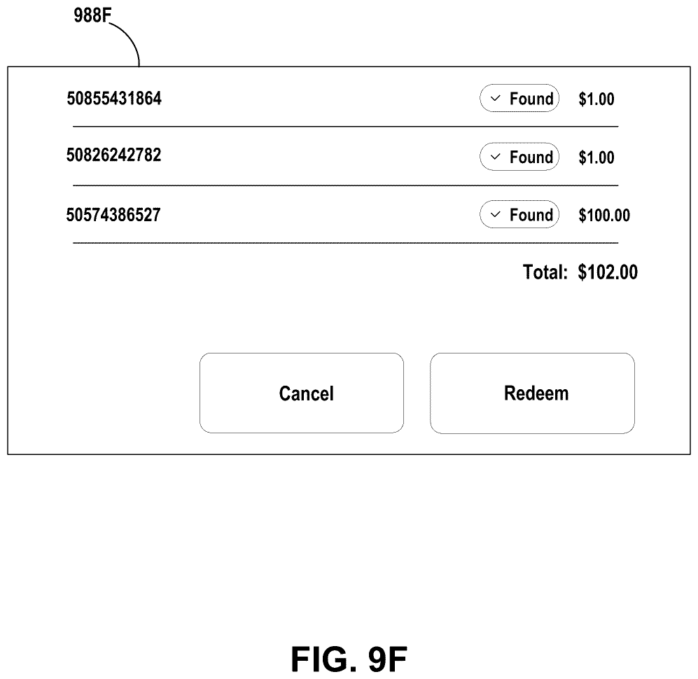

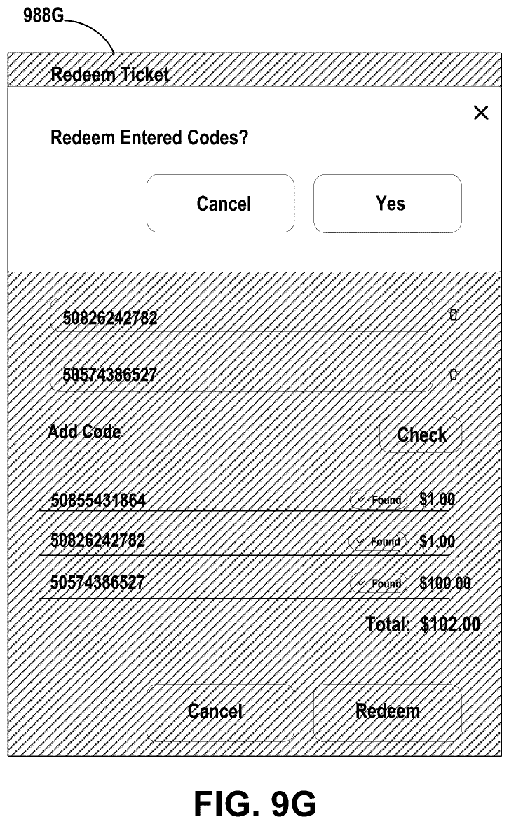

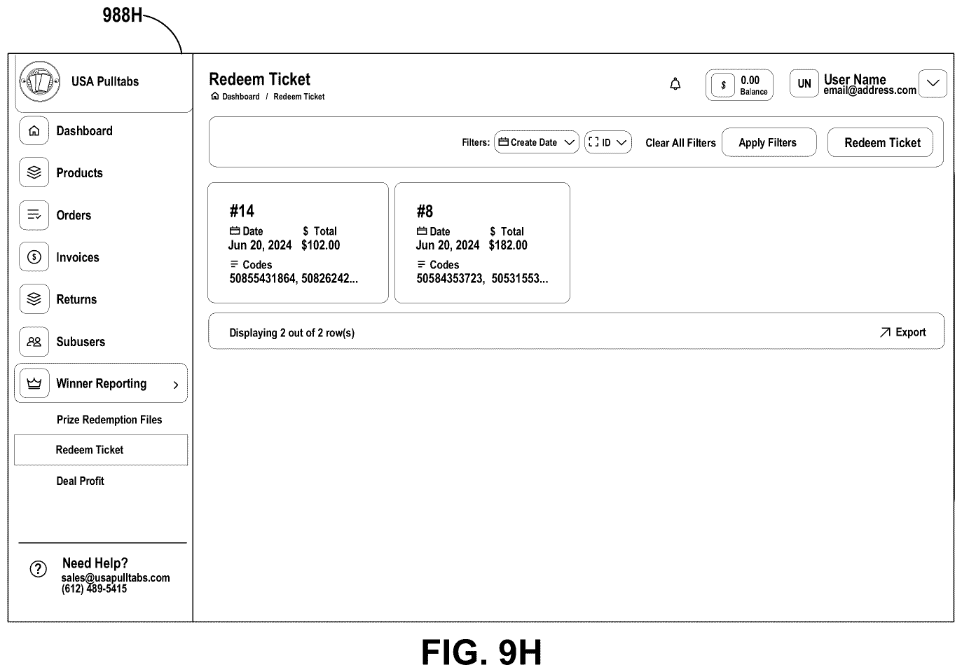

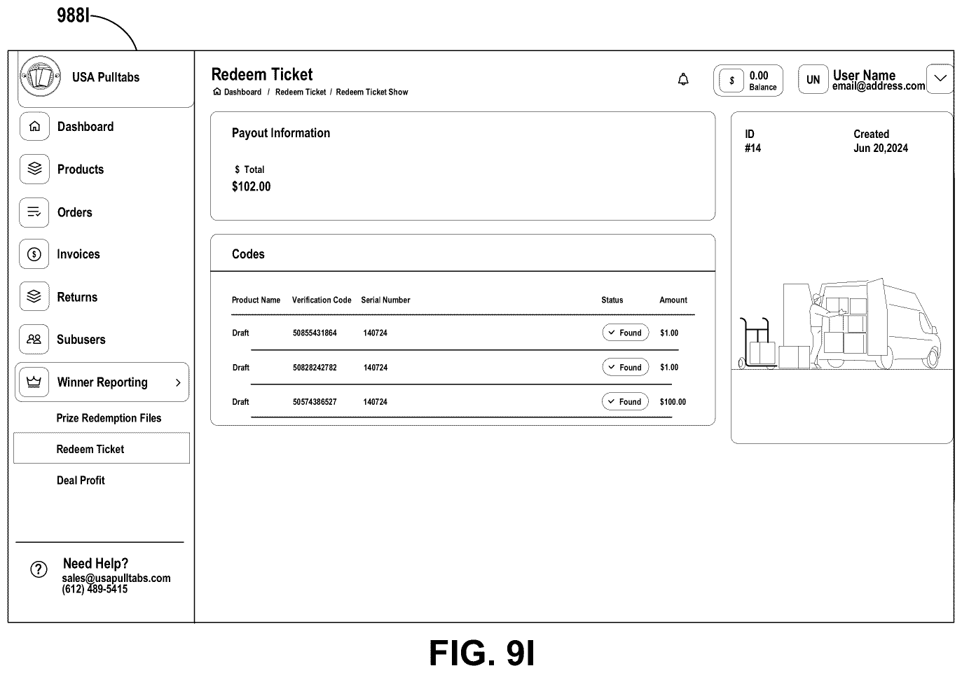

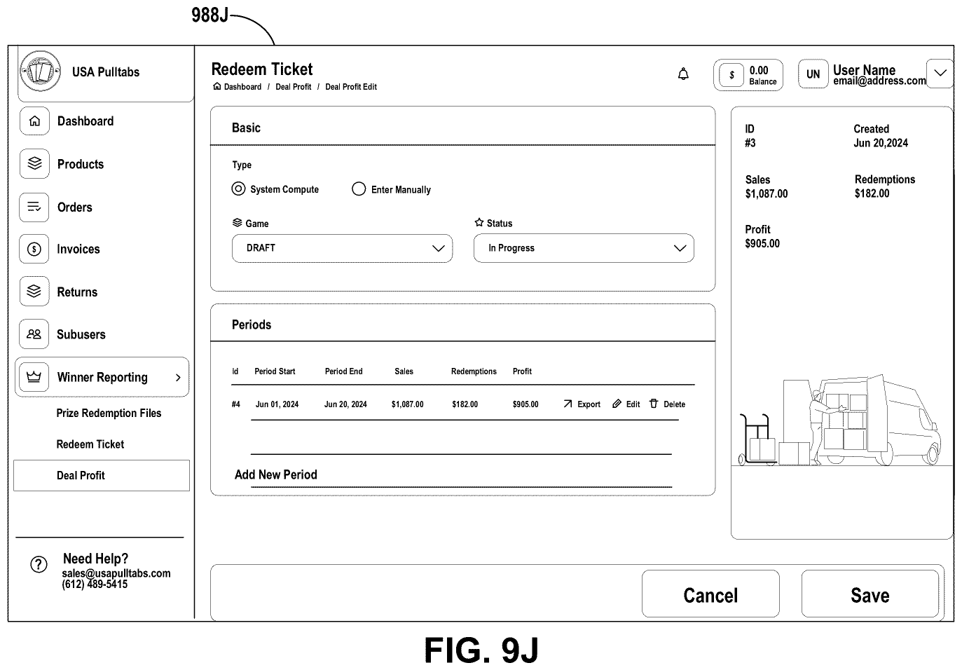

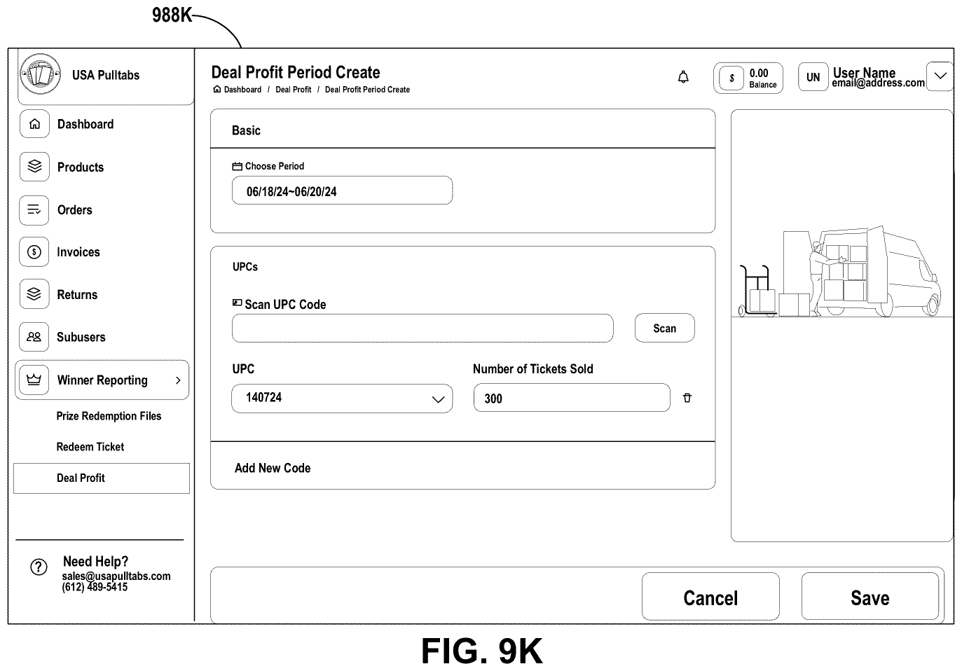

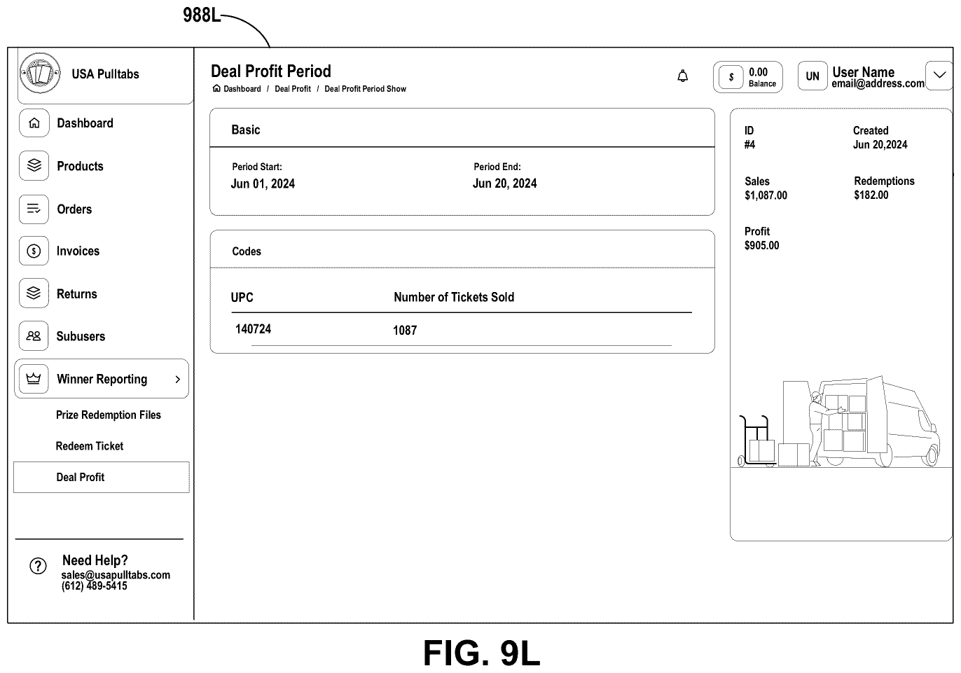

FIGS. 9A-9L are a series of screenshots 988A-988L, respectively, showing an example process for how an authorized user (e.g., a hosting establishment 104/204) with an appropriate prize-verification device 514 (e.g., POS 514B of FIG. 5B and/or mobile scanner 514C of FIG. 5C) can access CRM 210 (via website 778) to redeem a winning pulltab card 336 on behalf of a player 222. For instance, the authorized user (for instance a bar owner, bartender, or other authorized representative of a hosting establishment) can open a web browser on the prize-verification device 514 and use their personalized login credentials to access an instance of CRM 210, an example of which is shown in FIG. 9A. As shown in FIG. 9B, the authorized user can navigate to “Winner Reporting” and select “Redeem Ticket.” Once the GUI 988C of FIG. 9C is displayed on electronic display 564, the user can use the optical scanner 562 to scan the scannable code 456 on the winning pulltab card 336 (FIG. 9D), and then select “Check” on the electronic display 564 to verify the corresponding prize-verification code 454. In the case of multiple scannable codes, the user can scan all of the codes prior to selecting “Check” (FIG. 9E) in order to verify the validity of all of the pulltab cards simultaneously (FIG. 9F).

Once the validity of the pulltab cards has been checked, the user can select “Redeem” in order to redeem the winner(s) and pay out the corresponding cash prize(s) to the player(s) 222, as shown in FIG. 9G. As shown in FIG. 9H, CRM 210 is configured to automatically generate a redemption record for each redeemed pulltab cards-that is, the corresponding prize-verification codes will be marked as “redeemed” within the records of CRM 210. In this way, CRM 210 prevents unscrupulous players from attempting to redeem the same winning pulltab card more than once. As shown in FIG. 9I, by selecting “View,” the user can review additional details for all of the winning pulltab cards redeemed up to that point.

As shown in FIG. 9J, CRM 210 enables the user (e.g., the hosting establishment 104/204) to calculate an amount of profit generated through sales of the pulltab cards for a particular period. For instance, the user can navigate to “Deal Profit” and select “Add New.” The user can then select a particular pulltab game for which to record profit. CRM 210 will automatically generate a corresponding profit record, which the user can then use to periodically record income generated from sales of the cards. That is, CRM 210 enables the user to determine the amount of profit, either by manually entering prize redemptions (i.e., cash payouts for winning pulltab cards) when the prize-redemption device 214/514 verifies the ticket using game data 218 stored in local memory, and/or by computing total prizes redeemed online through CRM 210 via the process shown in FIGS. 9A-9H.

As shown in FIGS. 9K and 9L, the user can further use CRM 210 to determine the income/profit from pulltab-card sales for a particular period of time. For instance, the user can select “Add New Period” and then choose a redemption period, input the UPC of the game to display, and then manually enter the number of pulltab cards sold (CRM 210 will then automatically calculate the gross sales as the number of cards sold times the price per card). Upon clicking “Save,” CRM 210 will calculate and display the profit for the selected time period. Through CRM 210, the user is able to select and view as many profit-and-loss periods as desired—the system will continue aggregating total winning-card redemptions (YTD vs. selected period) and total card sales (YTD vs. selected period) until all of the pulltab cards for the selected game have been sold and/or all of the winning pulltab cards from that game have been redeemed.

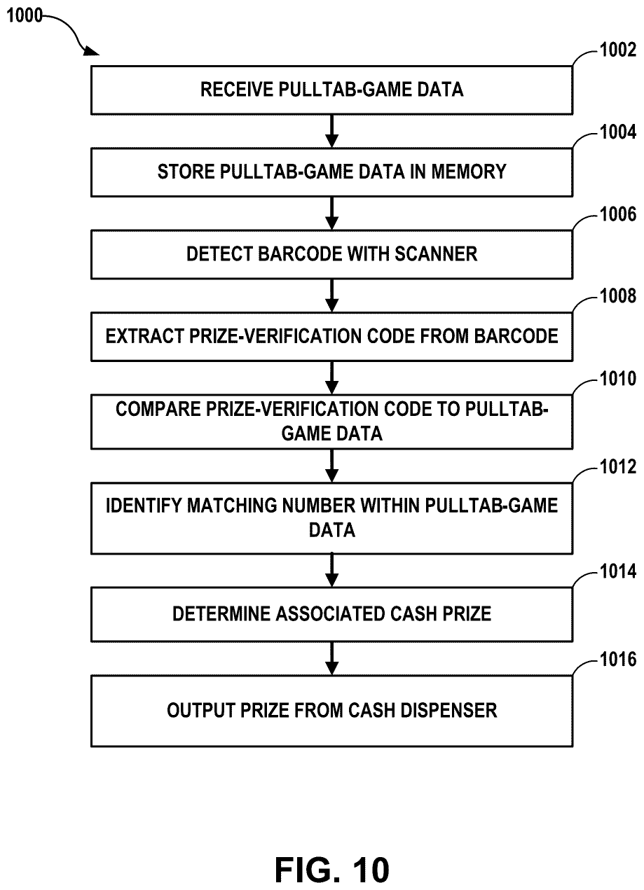

FIG. 10 is a flowchart illustrating a method or process 1000 for automating one or more aspects of a pulltab game. Process 1000 is described from the perspective of prize-redemption kiosk 514A of FIG. 5A.

At Step 1002, prize kiosk 514A receives a set of game data 218 for a new pulltab game, either locally, e.g., from a removable digital storage inserted into the kiosk, or remotely, e.g., via the Internet from a central computer 208. At Step 1004, prize kiosk 514A stores a copy of game data 218 in its local memory.

At Step 1006, prize kiosk 514A detects a scannable code 456, such as a barcode or QR code, printed on a pulltab card 336 placed in front of its integrated optical scanner 562A. Optical scanner 562A scans the code 456, and at Step 1008, extracts the prize-verification code 454 encoded thereby. At Step 1010, prize kiosk 514A compares the prize-verification code 454 to the complete set of prize-verification codes included in game data 218 stored in local memory. At Step 1012, prize kiosk 514A identifies a matching number, and also verifies that prize-verification code 454 has not already been redeemed, thereby confirming that pulltab card 336 is a valid, winning card. In such cases, at Step 1014, prize kiosk 514A retrieves, from within game data 218, a prize denomination corresponding to prize-verification code 454, and at Step 1016, automatically dispenses a cash prize from prize dispenser 566A, in an amount corresponding to the prize denomination.

Although the systems, devices, and methods of the invention have been described in connection with the field of trading cards, card-based games, and lottery-type gaming, it can readily be appreciated that the invention is not limited solely to such fields, and can be used in other fields.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

Although the invention or elements thereof may by described in terms of vertical, horizontal, transverse (lateral), longitudinal, and the like, it should be understood that variations from the absolute vertical, horizontal, transverse, and longitudinal are also deemed to be within the scope of the invention.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc., in question is (or is not) removable.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

The embodiments above are chosen, described and illustrated so that persons skilled in the art will be able to understand the invention and the manner and process of making and using it. The descriptions and the accompanying drawings should be interpreted in the illustrative and not the exhaustive or limited sense. The invention is not intended to be limited to the exact forms disclosed. While the application attempts to disclose all of the embodiments of the invention that are reasonably foreseeable, there may be unforeseeable insubstantial modifications that remain as equivalents. It should be understood by persons skilled in the art that there may be other embodiments than those disclosed which fall within the scope of the invention as defined by the claims. Where a claim, if any, is expressed as a means or step for performing a specified function it is intended that such claim be construed to cover the corresponding structure, material, or acts described in the specification and equivalents thereof, including both structural equivalents and equivalent structures, material-based equivalents and equivalent materials, and act-based equivalents and equivalent acts.

What is claimed is:

1. A device comprising:
an optical scanner configured to scan a scannable code printed on a pulltab card belonging to a set of pulltab cards of a pulltab game; and
processing circuitry configured to:
determine a prize-verification code encoded by the scannable code;
verify, based on the prize-verification code, that the pulltab card is a winning card;
determine that the winning card has not already been redeemed; and
responsive to determining that the winning card has not already been redeemed, output an indication of a cash prize associated with the winning card.

2. The device of claim 1, wherein the processing circuitry is configured to verify that the pulltab card is a winning card by comparing the prize-verification code to a set of game data stored in a local memory of the prize-verification device.

3. The device of claim 2, wherein the set of game data comprises a comma-separated values (.CSV) file comprising, for each of a plurality of winning cards of the pulltab game that includes the winning card:
a serial number of the pulltab game;
the prize-verification code;
a cash-prize denomination; and
a graphical card image displayed on a front side of the winning card.

4. The device of claim 2, wherein the processing circuitry is further configured to:
receive the set of game data via a removable digital storage device inserted into the prize-verification device; and
store the set of game data in the local memory.

5. The device of claim 2, wherein the processing circuitry is further configured to:
wirelessly receive the set of game data from a remote computing device; and
store the set of game data in the local memory.

6. The device of claim 1, wherein the processing circuitry device is configured to verify that the pulltab card is a winning card by transmitting the prize-verification code to a cloud-based platform and receiving a validity indicator in response.

7. The device of claim 1, wherein the prize-verification code comprises an eleven-digit numeric code.

8. The device of claim 1, wherein the scannable code comprises a barcode.

9. The device of claim 1, wherein the scannable code comprises a quick-response (QR) code.

10. The device of claim 1, wherein the device comprises a kiosk configured to automatically dispense the cash prize in response to determining that the winning card has not already been redeemed.

11. The device of claim 1, wherein the device comprises a point-of-sale (POS) terminal.

12. The device of claim 1, wherein the device comprises a handheld mobile computing device with an integrated optical scanner.

13. A system comprising:
the device of claim 1; and
a computer network configured to generate the pulltab game by generating:
a set of game data comprising a plurality of randomized game entries; and
a set of card graphics corresponding to the set of game data, wherein the set of pulltab cards comprises the set of card graphics.

14. The system of claim 13, further comprising a printer configured to print the card graphics onto sheets of cardboard for subsequent assembly into the set of pulltab cards.

15. The system of claim 13, further comprising the set of pulltab cards including the winning card, wherein the winning card comprises:
a plurality of perforated tabs;
a winning game entry printed underneath one of the perforated tabs; and
the prize-verification code printed underneath another one of the perforated tabs.

16. The system of claim 15, wherein the winning card further comprises a quick-resource (QR) code encoding a uniform resource locator (URL) of a webpage corresponding to a periodic prize drawing.

17. A method comprising:
scanning, by a prize-verification device, a scannable code printed underneath a perforated tab on pulltab card of a pulltab game;
determining, by the prize-verification device based on the scannable code, a prize-verification code encoded by the scannable code;
verifying, by the prize-verification device based on the prize-verification code, that the pulltab card is a winning card;
determining, by the prize-verification device based on the prize-verification code, that the pulltab card has not already been redeemed; and
outputting, by the prize-verification device in response to determining that the pulltab card has not already been redeemed, an indication of a cash prize associated with the prize-verification code.

18. The method of claim 17, wherein verifying that the pulltab card is a winning card comprises comparing the prize-verification code to a set of game data stored in a local memory of the prize-verification device.

19. The method of claim 18, wherein the set of game data comprises a comma-separated values (.CSV) file comprising, for each of a plurality of winning cards of the pulltab game that includes the winning card, a set of values indicating:
a serial number of the pulltab game;
the prize-verification code;
a prize denomination; and
a graphical card image displayed on a front side of the winning card.

20. The method of claim 17, wherein verifying that the pulltab card is a winning card comprises transmitting the prize-verification code to a cloud-based computing device and receiving a validity indicator in response.
